(19) United States
(12) Patent Application Publication
(10) Pub. No.: US 2011/0141904 A1
(43) Pub. Date: Jun. 16, 2011

(54) METHOD AND APPARATUS FOR TRANSMITTING PACKETS OF A TWO-WAY PASSENGER DATA STREAM

(75) Inventors: Pascal Viger, Janze (FR); Stéphane Baron, Le Rheu (FR)

(73) Assignee: CANON KABUSHIKI KAISHA, Tokyo (JP)

(21) Appl. No.: 12/966,374

(22) Filed: Dec. 13, 2010

(30) Foreign Application Priority Data
Dec. 14, 2009 (FR) 09/58941

(51) Int. Cl. H04L 12/26; H04L 12/56

(52) U.S. Cl. 370/241; 370/389

(57) ABSTRACT

A method is proposed for transmitting packets of a two-way passenger data stream set up between first and second terminal devices. The passenger stream is compliant with a passenger transport protocol with acknowledgement defining a plurality of packet categories, and is intended to be encapsulated by a manager device according to an encapsulating transport protocol with acknowledgement. The manager device obtains a packet of the passenger stream transmitted from the first terminal device to the second terminal device, makes a first check to see if the packet obtained belongs to at least one predetermined category among the plurality of packet categories and, in the event that the first check is positive, encapsulates at least one part of the data of the obtained packet according to an encapsulating transport protocol without acknowledgement.

### CROSS-REFERENCE TO RELATED APPLICATIONS

This application claims the benefit under 35 U.S.C. §119(a)-(d) of French Patent Application No. 0958941, filed on Dec. 14, 2009 and entitled “Method for transmitting packets of a two-way passenger data stream, corresponding manager device, computer program product and storage means”.

The above cited patent application is incorporated herein by reference in its entirety.

### BACKGROUND OF THE INVENTION

1. Field of the Invention

The present invention relates to communications networks.

A particular but non-exclusive application of the present invention is a technique for transmitting packets of a two-way passenger data stream set up between first and second terminal devices (also called sender/receiver devices), the transmission being done by encapsulation of the packets of the passenger stream. It is assumed that the passenger stream is compliant with a passenger transport protocol with acknowledgement (TCP for example). It is also assumed that the passenger stream is intended to be encapsulated by a manager device according to an encapsulating transport protocol with acknowledgement (TCP for example).

2. Description of the Related Art

The TCP (Transmission Control Protocol) is a connection-oriented (i.e. working in connected mode), “reliable” transport protocol (i.e. the TCP protocol works in connected mode). Thus, the TCP gives a reliable byte stream enabling the arrival of data without deterioration and in the right order with re-transmission in the event of loss and elimination of duplicated data. The TCP attempts to deliver all the data correctly and in sequence. It is its aim and main advantage over the UDP protocol even if it may be a disadvantage for transfer applications or for the real-time routing of streams, with high loss rates in the network layer. The FTP (file transfer) and HTTP (web) transport protocols for example are based on the TCP.

During a communication according to the TCP, two machines must set up a connection in order to exchange data packets called data segments in a two-way connection. The sender machine sending a connection request is called a client (or client device) while the receiver machine receiving the connection request is called a server (or server device). It is said in this case that this is a client-server environment. The machines in such an environment communicate in connected mode, i.e. the communication is done in both directions.

It is important to note that the client and the server are both terminal devices (sender/receiver devices) in the sense that each of them sends and receives data segments. Here below, in the description, to qualify a machine or a device, the adjectives sender and receiver will be used only with reference to the sending and receiving of data segments (in order to avert any confusion with the notions of sending or receiving a connection request).

As presented in greater detail here below with reference to FIG. 7, the TCP distinguishes several categories of segment (a same segment can belong to several categories, one or more flags included in the header of the segment indicating the category or categories to which the segment or segments belong), and especially:

the acknowledgement segments or ACK segments enabling the client and the server to ensure efficient mutual reception of data. An ACK segment contains a reception acknowledgement number (also called an acknowledgement sequence number) equal to the data sequence number of the next segment awaited by the machine (client or server) that sends the ACK segment; and

the full data transmission segments, also called PUSH segments (or PSH segments) enabling a first machine (a server for example) which has sent a PUSH segment to tell a second machine (a client for example) that a PUSH function has to be implemented, i.e. that the data items collected by this second machine (including the data items contained in the PUSH segment) and stored in the TCP reception buffer memory of this second machine have to be transferred immediately to a destination application without waiting for other following data if any. In other words, the first machine which sends the PUSH segment sends out a need for data consumption by the second machine (this need resulting for example from the fact that the end of the data to be transmitted has been reached, and owing to a congestion of the TCP sending buffer memory of the first machine).

The UDP (User Datagram Protocol) is a simple transport protocol without connection (i.e. it works in packet mode or datagram mode enabling an optimum but non-reliable bit rate: the UDP does not check the fact that the packets have reached their destination and does not ensure their arrival in the right order. If an application needs these guarantees, it must provide for them itself or else use the TCP protocol. The UDP protocol is generally used by multimedia broadcasting applications (audio and video etc) for which the time required by the TCP to manage the re-transmission and scheduling of the packets is not available.

In the case of data transmission through a level 2 tunnel, the TCP passenger session (for example for the transport of a passenger video stream via HTTP/TCP according to the UPnP (Universal Plug and Play) recommendation or DLNA (Digital Living Network Alliance)) recommendation is encapsulated (in full transparency for the passenger stream) in a new session of the tunnel (TCP, UDP or other session). It is this new session that will ensure communication between the two tunnel end-points, thus enabling the crossing of a network of a different nature (such as the Internet for example). The apparatuses (for example of the UPnP or DLNA type) of the LAN 103 or 104 are generally sized for use on the LAN. For example, the TCP sending memory (i.e. the buffer storage memory for the sending operation according to the TCP), of a UPnP server (113) is generally sized to manage a connection on a LAN in a fluid manner (65 kilobytes are suited to a “round-trip time” or RTT (i.e. the time taken by a packet to reach its destination and for the corresponding acknowledgement to be sent back and be received by the sender) equal to 5 ms and a bit rate of 100 Mbps.

The RTT increases very significantly during routing through a level 2 tunnel (several hundreds of milliseconds). The TCP stream (passenger stream of the tunnel) is then sent in bursts by the apparatuses of the LAN. Each burst is due to the wait for reception, by the server 113, of the acknowledgements (ACK segments) from a client 108 for data sent beforehand by the server 113: each received acknowledgement releases space in the TCP sending memory of the server 113 for future data to be transmitted. The TCP passenger sessions of the tunnel therefore do not benefit from all the available transport capacity, and their transmission speed is then considerably reduced. Thus, the latency for the reception of the TCP acknowledgement packets (ACK segments) is critical in the performance of the TCP passenger sessions of the tunnel.

When there is a temporary congestion of the VPN tunnel set up on a wide area network (WAN) such as the Internet for example, if the carrier of this tunnel uses a reliable communications protocol with acknowledgements (i.e. for example a transport channel of this tunnel using the TCP protocol), it will go into automatic re-transmission. The will result in a suspension of all the passenger streams conveyed through this transport channel of the tunnel (even streams not directly concerned by the loss of encapsulating packets (i.e. embedding packets) of the carrier of the tunnel). Indeed, several passenger streams can be conveyed by a same transport channel (i.e. a same carrier or again a same communications session) of the tunnel. Furthermore, by construction, the TCP protocol implemented on the TCP carrier of the tunnel ensures the order of arrival of the packets and does not give the packets of the tunnel that come after the packet lost in this tunnel in advance to the receiver entity 102. This means that the receiver tunnel end-point 102 will not transfer the received passenger packets, for which the data sequence number of the conveying packet of the carrier is higher than the number corresponding to the lost packet of this carrier of the tunnel, to the remote LAN 104 but will store these packets in the reception memory of the TCP carrier of the tunnel. The stored passenger packets will be unblocked only when the lost packet is re-transmitted by the sender tunnel end-point 101 and received by the receiver tunnel end-point 102.

In the case of the transport of the passenger TCP streams of the tunnel, it may be recalled that stored and blocked TCP packets (waiting in the reception memory of the TCP carrier included in the receiver tunnel end-point 102) may be of any nature (in particular, they may be ACK segments without data, ACK segments with data, ACK and PUSH segments with data, PUSH segments with data etc).

The fact that packets of a data stream are stored and blocked together appears to be reasonable for the data containing these packets. Indeed, this ensures their order of arrival. However, should these stored and blocked packets contain acknowledgement information (i.e. should these packets be ACK segments), this is detrimental to the acknowledgement information, which is blocked and therefore delayed. Indeed, since the sender of the data segments to which the delayed acknowledgement information pertains (i.e. the server 113 in the present example) awaits acknowledgement information, it is limited in its possibility of sending (congestion window not updated, preventing the sending of new data packets by the server 113 and prompting a saturation of the TCP sending memory of the server 113).

Thus, if we consider (see FIG. 1) an FTP or HTTP (over TCP) connection between the server 113 and a client 108, a re-transmission on the TCP carrier of the tunnel 100 (for example for the tunnel segments transmitted from the first tunnel end-point 101 to the second tunnel end-point 102) will delay the ACK segments coming from the client 108 to the server 113 (for the TCP passenger stream traveling on the tunnel 100). Now, this server 113 is waiting for these ACK segments in order to be allowed to transmit new data according to the TCP protocol.

This is also detrimental when the stored and blocked packets are PUSH segments. Indeed, the receiver of a delayed PUSH segment (i.e. the server 113 in this example) receives delayed knowledge of the request made to it for immediate transfer of the collected data to the local destination applications layer.

Most of the principles of the end-to-end protocols rely on the addition of a specialized PEP (Performance Enhancing Proxy) type agent to the infrastructure apparatus between the heterogenous type networks (typically tunnel end-points for the WANs or base stations for wireless networks). For example the RFC 3135 standard describes a standard to reduce congestion of acknowledgments. An ACK filtering technique of this kind is however not completely satisfactory in resolving the above-mentioned problem. The U.S. Pat. No. 7,315,515 explains that several problems have been noted when the return path of a TCP connection does not have sufficient bandwidth to let through all the acknowledgments (ACKs) generated by the destination device. This is the case with users downloading information from the Internet through a high-bit-rate link in the downlink direction (for example a satellite link or else a cable), and sending the requests and ACK segments on a low-bit-rate link in the uplink direction. Congestion appears on the return path, causing deterioration in the bit rate of the connection and a problem of inequality when there are several connections competing for the return path.

The filtering of the ACK segments entering the bottleneck has been proposed in the U.S. Pat. No. 7,315,515 to eliminate this congestion. In a modem device or gateway, an ACK segment that reaches a reception buffer of this modem device or gateway, in order to be transmitted from a LAN to an Internet device, is compared with the ACK segments previously stored in this reception buffer memory. If a certain number of other ACK segments of the same connection are found, the technique proposed in the above-mentioned patent document consists in erasing (i.e. eliminating) some of these ACK segments, and the new ACK segment received takes their place. This mechanism relies on the property of cumulative acknowledgment of the TCP protocol (for a given TCP data stream, an acknowledgment for a sequence “n+1” acknowledges the sequence “n” by default). Thus, the elimination of the “redundant” ACK segments releases space in the reception buffer memory of the modem or gateway.

However, the application of the technique proposed in the U.S. Pat. No. 7,315,515 is restrictive because, should an unspecified ACK segment comprise other pieces of information, then it is provided that this ACK segment will annihilate the proposed mechanism. This is particularly detrimental as a TCP connection is essentially a two-way connection, and it is common practice to associate the sending of data of a first stream (for example an HTTP or FTP command) with an acknowledgment for a second stream in the opposite direction (for example the HTTP stream being downloaded), the first and second streams together forming a two-way data stream.

The technique proposed in the U.S. Pat. No. 7,315,515 gives poor performance in short transfers or after a recovery on loss. This is especially so because the slow start phase of the TCP protocol relies on the number of ACK segments received. Erasing all the ACK segments is a highly aggressive operation which has very detrimental effects on this slow start phase, during which the ACK segments arrive in bursts and where the greatest possible number of ACK segments must be passed to the source device to help in the rapid increase of its congestion window.

### SUMMARY OF THE INVENTION

According to an aspect of the present invention, a method for transmitting packets of a two-way passenger data stream set up between first and second terminal devices, wherein the passenger data stream is compliant with a passenger transport protocol with acknowledgement defining a plurality of packet categories and is intended to be encapsulated by a manager device according to an encapsulating transport protocol with acknowledgement, comprising the steps of; obtaining a packet of said passenger stream transmitted from the first to the second terminal device; making a first check to see if the packet obtained belongs to at least one predetermined category among said plurality of categories of packet; and encapsulating, in the event of a first positive check, at least one part of the data of said packet obtained according to an encapsulating transport protocol without acknowledgement is disclosed.

And according to another aspect of the invention, a method for transmitting TCP passenger packets from a first terminal device to a second terminal device, said passenger TCP stream being intended to be encapsulated by a manager device according to an encapsulating transport protocol with acknowledgement before being transmitted to the second terminal device, wherein the manager device performs encapsulating acknowledgement portions of TCP passenger packet received from the first terminal device, according to an encapsulating transport protocol without acknowledgement, is disclosed.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 provides a schematic illustration of a classic configuration of a virtual private network (VPN) implementing a communications tunnel.

FIG. 2 provides a schematic illustration of a classic model in protocol layers of a tunnel end-point in which the method according to one embodiment of the invention can be implemented;

FIG. 3 is a schematic illustration of a format of an Ethernet frame in the context of the implementation of a level 2 tunnel;

FIG. 4 is a schematic illustration of the functional blocks included in the tunnel end-points according to one embodiment of the invention;

FIG. 5 is a flowchart of a particular embodiment of the method according to the invention implemented by a tunnel end-point;

FIG. 6 is a flowchart giving a detailed description of a particular embodiment of the test step 503 of FIG. 5;

FIG. 7 provides a schematic illustration of the structure of a TCP segment.

### DESCRIPTION OF THE EMBODIMENTS

Various exemplary embodiments, features, and aspects of the invention will be described in detail below with reference to the drawings.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

The invention, in at least one embodiment, is aimed especially at overcoming different drawbacks of the prior art.

More specifically, it is a goal of at least one embodiment of the invention to provide a technique for transmitting packets of a two-way passenger data stream set up between the first and second terminal devices, a transmission being done by encapsulation of the packets of the passenger stream, this technique being used to accelerate the end-to-end connection between the first and second terminal devices when this stream is compliant with a passenger transport protocol with acknowledgement (TCP for example).

It is also an aim of at least one embodiment of the invention to provide a technique of this kind for accelerating the draining of the sender buffer memories of the first and second terminal devices.

It is another goal of at least one embodiment of the invention to provide a technique of this kind for accelerating the transmission of information related to one or more particular categories of packets defined by the passenger transport protocol with acknowledgement (especially information related to the ACK segments and/or PUSH segments when the passenger transport protocol with acknowledgement is a TCP).

It is an additional goal of at least one embodiment of the invention to provide a technique of this kind that has limited impact on the processor consumption of the manager device (for example a tunnel end-point) in which this technique is implemented.

It is another goal of at least one embodiment of the invention to provide a technique of this kind that can be implemented when a tunnel is set up between the first and second terminal devices.

In one particular embodiment of the invention a method is proposed for transmitting packets of a two-way passenger data stream set up between first and second terminal devices, said passenger stream being compliant with a passenger transport protocol with acknowledgement defining a plurality of packet categories, said passenger stream being intended to be encapsulated by a manager device according to an encapsulating transport protocol with acknowledgement. The manager device performs steps for:
obtaining a packet of said passenger stream transmitted from the first to the second terminal device;
making a first check to see if the packet obtained belongs to at least one predetermined category among said plurality of categories of packet;
in the event of a first positive check, encapsulating at least one part of the data of said packet obtained according to an encapsulating transport protocol without acknowledgement.

The general principle is that of selecting a packet of the passenger stream as a function of its protocol packet content (for example one packet is selected if it is an ACK and/or PSH segment) and then encapsulating at least one (priority) part of this selected packet according to an encapsulating transport protocol which is without acknowledgement (such as for example the UDP encapsulating transport protocol) and not as planned according to an encapsulating protocol which is with acknowledgement (for example the TCP encapsulating transport protocol).

Thus, this particular embodiment relies on a wholly novel and inventive approach taking advantage of the fact that the encapsulating transport protocol without acknowledgement is faster than the encapsulating transport protocol with acknowledgement, because it is simpler (with a lighter header, no congestion control or management of sequencing) and is not subjected to blocks due to re-transmissions (with no “reliabilizing” or reliability creating service). Indeed, the transmission of a part of the data of the selected packet is accelerated by encapsulating the pieces of data according to the encapsulating transport protocol without acknowledgement.

Advantageously, the manager device performs a step for making a second check to see if the packet obtained includes payload data. In the event of first and second positive checks, the manager device carries out a packet creating phase comprising steps which, for said packet obtained or at least one of said packets obtained, are steps for:
creating a new packet into which a part of the obtained packet related to said at least one predetermined category has been copied;
encapsulating the new packet according to the transport protocol without acknowledgement;
encapsulating the payload data according to the transport protocol with acknowledgement.

Thus (at least) the payload data items continue to benefit from the reliabilizing (i.e. reliability creating) process associated with the encapsulating transport protocol with acknowledgement.

Advantageously, in a first implementation, the step for encapsulating the payload data according to said transport protocol with acknowledgement includes the step for encapsulating the packets obtained according to the transport protocol with acknowledgement.

This first implementation is very simple because the packet obtained (original packet) is encapsulated intact according to the encapsulating transport protocol with acknowledgement. Furthermore, it optimizes the reliabilization since the entire original packet is encapsulated according to the encapsulating transport protocol with acknowledgement.

Advantageously, in a second implementation, the step for encapsulating the payload data according to the transport protocol with acknowledgement comprises steps for:
modifying the packet obtained by extracting said copied packet from the packet obtained;
encapsulating the modified packet according to the transport protocol with acknowledgement.

This second implementation limits the load of the transport medium used with the encapsulating transport protocol with acknowledgement (the entire original packet is not transmitted on this medium). As a trade-off, it requires more processor resources than the first implementation since it is necessary to modify the original packet before encapsulating it according to the encapsulating transport protocol with acknowledgement.

According to one advantageous characteristic, in the event of a first positive check and a second negative check, the manager device performs a step for encapsulating the obtained packet, according to the transport protocol without acknowledgement.

In this case, it is not necessary to create and transmit a new packet, and this requires no processor resources whatsoever. Furthermore, since the packet obtained (original packet) is not encapsulated according to the encapsulating transport protocol with acknowledgement, the load of the transport medium that it uses is reduced.

Advantageously, said at least one predetermined category belongs to the group comprising:
a category grouping together acknowledgement packets transmitted by the first terminal device to inform the second terminal device of the reception of one or more packets pre-transmitted by the second terminal device; and
a category grouping together complete data transmission packets transmitted by the first terminal device to inform the second terminal device that the payload data collected by the second terminal device must be transmitted to a destination application without waiting for following payload data if any.

For each acknowledgement packet (i.e. each ACK segment), the part encapsulated according to the encapsulating transport protocol with acknowledgement comprises information on acknowledgement, but not any payload data that may be included in the ACK segment. By contrast, for each complete data transmission packet (i.e. each PUSH segment), the party encapsulated according to the encapsulating transport protocol without acknowledgement comprises PUSH information as well as payload data. A packet may belong both to the ACK category and to the PUSH category. If this is the case, the encapsulated part according to the encapsulating transport protocol without acknowledgement comprises the different elements referred to here above and related to each of two categories mentioned here above.

In the case of a packet of the ACK category, the acceleration of the transmission of acknowledgement information enables the sender (of the data segments to which the acknowledgement information pertains) to release its sending buffer memory more quickly. In other words, the end-to-end connection for the passenger stream is accelerated.

Furthermore, should the acknowledgement information be copied and sent twice (once in the new packet encapsulated according to the encapsulating transport protocol without acknowledgement and once in the original packet encapsulated according to the encapsulating transport protocol with acknowledgement), this increase in the number of packets of the ACK category transmitted is very useful. Indeed, assuming that the encapsulating transport protocol without acknowledgement uses a first medium (a UDP carrier for example) and that the encapsulating transport protocol with acknowledgement uses a second medium (TCP carrier for example):

if there has been no loss on the first carrier, the sender (of the data segments to which the acknowledgement information relates) will receive two identical packets of the ACK category at best, and this raises no problem (for example if the passenger transport protocol is the TCP protocol, this number is below the threshold for activating a transmission, namely three DUP-ACK segments and one original ACK segment, giving four identical ACK segments). Hence, more packets of the ACK category are sent than in the prior art, leading to the possibility of a faster increase or a faster growth of the congestion window of the above-mentioned sender;

if a whole set of new packets of the ACK category (created and sent on the first medium) is lost, we nevertheless return (through the transmission on the second medium) to the usual context of a transmission on a medium using a transport protocol with acknowledgement (TCP protocol for example);

if at least one packet of the ACK category arrives through the first medium (the others being lost), it will have enabled the sending buffer memory of the above-mentioned sender to be released more rapidly, and then the other packets of the ACK category received through the second medium will be perceived as being out of order (delayed) but they will nevertheless contribute to increasing the congestion window of the above-mentioned sender. It must be noted that, for a same rate of loss on the network, the sender (the source) receives more packets of the ACK category than it does through the known acknowledgements filtering technique. Indeed, packets created and sent on the first medium are subjected only to a loss rate on the corresponding section of the network (between the tunnel end-point and an Internet gateway for example), and this corresponds to far less than the number of packets of the ACK category eliminated by the known acknowledgements filtering technique. Now each packet of the ACK category received by the sender enables it to increase its sending capacity. By sending out more packet of the ACK category (and complying with the threshold limit of activation of transmission according to the passenger protocol with acknowledgement), the sending capacity of the source is multiplied correspondingly.

In the case of a packet of the PUSH category, the acceleration of the transmission of PUSH information and of the associated payload data enables the sender (of this packet of the category PUSH) to give a quicker alert to the receiver (of this PUSH category packet) of the action to be undertaken (namely the immediate transfer data collected to the destination application). In other words, the end-to-end connection for the passenger stream is accelerated.

Advantageously, if the packet obtained is an acknowledgement packet, the manager device performs a step for carrying out a third check to see if one of the following two conditions is fulfilled:
seen from a destination apparatus that has generated said acknowledgement packet, a re-transmission of data according to the passenger transport protocol is or should be initiated;
seen from a source apparatus, a re-transmission of data according to the passenger transport protocol should not be initiated even if said source apparatus receives said acknowledgement packet as well as a new packet created by said packet creating phase,
   and said packet creating phase is performed only in the event of first, second and third positive checks.

Thus, the number of identical acknowledgement packets (DUP ACK according to the TCP protocol) transmitted to the second terminal device is managed. An additional acknowledgement packet is sent only if a re-transmission is or must be initiated or else if the sending of such an additional acknowledgement packet does not prompt an undesired activation of a re-transmission.

Advantageously, the manager device performs a step for making a fourth check to see if the following two conditions are fulfilled:
seen from said destination equipment, having generated said acknowledgement packet, a re-transmission of data according to the passenger transport protocol should not be initiated;
seen from the source apparatus, a re-transmission of data according to the passenger transport protocol will have to be initiated if said source apparatus receives said acknowledgement packet,
   and in the event of a fourth positive check, the manager device performs steps for:
modifying the packet obtained by extracting said copied part from the packet obtained to obtain a modified packet which does not have an acknowledgement packet;
encapsulating the modified packet according to the transport protocol with acknowledgement.

Thus, the source apparatus is prevented from going into re-transmission when the destination apparatus has not requested such re-transmission. Indeed, by modifying the obtained packet (the original packet) to divest it of its character of an acknowledgement packet, compensation is effected, in terms of number of acknowledgement packets sent to the second terminal device, with a new acknowledgement packet preliminarily created and transmitted to the second terminal device.

Advantageously, the manager device performs a step for making a fifth check to see if the packet obtained belongs to at least one category different from said at least one predetermined category. Said packet creating phase is performed only in the event of first, second and fifth positive checks.

Packets belonging to the at least one determined category as well as to the at least one other particular category must be reliabilized and therefore transported through a medium according to an encapsulating transport protocol with acknowledgement. There would be no point in sending two copies of these packets, one through a first medium according to an encapsulating transport protocol with acknowledgement and the other through a second medium according to an encapsulating transport protocol without acknowledgement.

Advantageously, said at least one different category belongs to the group comprising:
a category combining packets for initializing connections between said terminal devices;
a category grouping together packets indicating end of transmission.

For example, in the case of the TCP protocol, segments belonging to both the SYN category and the ACK category or else to both the END category and the ACK category are packets that need to be reliabilized.

Advantageously, the manager device performs a step for making a sixth check to see if it has been determined that there is congestion on a network transmitting said passenger stream. Said phase for creating packets is done only in the event of first, second and fifth positive checks.

Thus, in the event of congestion, the number of packets sent (not the new packet created) is not made unnecessarily cumbersome, and the creation and sending of new acknowledgements, which would further accelerate the transmission of packets by the second terminal device, is prevented.

Advantageously, the manager device performs a step for making a seventh check to see if a rate of use of the processor resources of said manager device is smaller than or equal to a predetermined threshold. Said packet creating phase is performed only in the event of first, second and seventh positive checks.

In this way, the use of the resources of the manager device is optimized. For example, to find a compromise between a rate of use of the processor resources of the manager device and the rate of acceleration (which enables the present invention), it is possible to limit the application of the invention to the creation of a new packet for n packets obtained (original packets).

Advantageously, a tunnel comprising first and second carriers is implemented between said first and second terminal devices. Said encapsulating transport protocol with acknowledgement is used with said first carrier and said encapsulating transport protocol without acknowledgement is used with said second carrier. Said manager device is a tunnel end-point placed between the first terminal device and the tunnel.

Thus, the present invention can be applied especially but not exclusively when a tunnel is implemented between the first and second terminal devices. In this case, the invention proposes a PEP mechanism for copying priority information included in the original packet (acknowledgement information and/or PUSH information for example) for passenger connections (for example TCP) of the tunnel. This PEP mechanism is aimed at improving the performance of these end-to-end connections.

In another embodiment, the invention pertains to a computer program product comprising program code instructions for implementing the above-mentioned method (in any of its different embodiments) when said program is executed on a computer.

In another embodiment, the invention pertains to a computer-readable storage means, possibly totally or partially detachable, storing a computer program comprising a set of instructions executable by a computer to implement the above-mentioned method (in any of its different embodiments).

In another embodiment, the invention pertains to a manager device capable of participating in a transmission of packets of a two-way passenger data stream set up between first and second terminal devices, said passenger stream being compliant with a passenger transport protocol with acknowledgement defining a plurality of packet categories, said passenger stream being intended to be encapsulated by a manager device according to an encapsulating transport protocol with acknowledgement. The manager device comprises:
means for obtaining a packet of said passenger stream transmitted from the first to the second terminal device;
means for making a first check to see if the packet obtained belongs to at least one predetermined category among said plurality of categories of packet;
means, activated in the event of a first positive check, for encapsulating at least one part of the data of said packet obtained, according to an encapsulating transport protocol without acknowledgement.

Advantageously, the manager device comprises means for implementing steps that it performs in the method as described here above, in any one of its different embodiments.

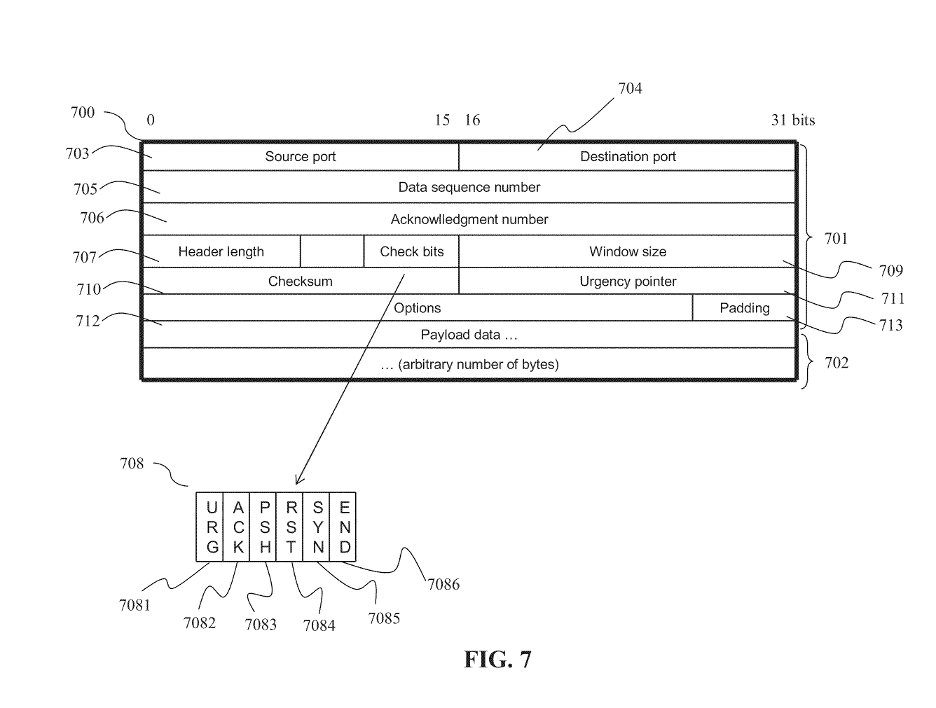

Referring now to FIG. 7, we recall some essential characteristics of the TCP (Transmission Control Protocol) as defined by the RFC 793 standard.

This is an ARQ (Automatic Repeat reQuest) type protocol which has been created in order to provide for data transfers on the Internet according to high-level criteria of speed and quality. At least two mechanisms are used to manage the excess traffic arriving at a receiver: the first one consists of the use of buffer reception memories and the second one sets up a stream control.

The TCP protocol provides for the reliable transfer of data, although it uses the IP protocol which incorporates no datagram delivery controls. Indeed, the TCP protocol has an acknowledgement system or ACK system enabling two machines (one of them being called a client or client device while the other is called a server or server device) to ensure efficient mutual reception of data exchanged in two-way communication. It may be recalled that the client and the server are both terminal devices (or sender/receiver devices or again sender/receiver machines) in the sense that each of them sends and receives data segments (the data streams between the client and the server is a two-way stream).

When a data segment (also called a data packet) is sent, a data order number (also called a data sequence number) is associated. At reception of a data segment, the machine receiving this data segment will return another data segment whose ACK flag is at 1 (in order to signal the fact that this is an acknowledgement of reception) accompanied by an acknowledgement of reception number (also called an acknowledgement sequence number) equal to the data sequence number of the received segment incremented by 1. Indeed, the acknowledgement sequence number corresponds to the data sequence number of the next expected segment (and not the data sequence number of the last received segment).

The setting up of a TCP connection between a client and a server is done in three stages:

in a first stage, the client sends a data segment whose flag SYN is a 1 (such a segment is also called a “SYN message”) to report the fact that this is a synchronization segment, with its initial data sequence number (ISN=x);

in a second stage, the server receives the synchronization segment coming from the client and then sends it an acknowledgement of reception, i.e. a data segment whose flag ACK is at 1 and whose flag SYN is at 1, comprising its own data sequence number (ISN=y), but it must also acknowledge the previous packet, which it does with a reception acknowledgement number (acknowledgement sequence number) which contains the initial order number (data sequence number) of the client incremented by one (ack=x+1);

in a third stage, the client sends an acknowledgement of reception to the server, i.e. a segment whose flag ACK is at 1 and whose flag SYN is at 0, because this is no longer a synchronization segment. Its order number (data sequence number) is incremented (seq=x+1) and the acknowledgement of reception number (acknowledgement sequence number) represents the initial order number (data sequence number) of the server incremented by one (ack=y+1).

Once this phase known as the “three-way handshake” is completed, the two applications (on the client side and server side) are in a position to exchange the bytes that warrant the setting up of the connection.

For a given direction of transmission of the two-way data stream between the client and the server, one of these two machines is called the source (generating the main data of the stream) and the other (receiving the main pieces of data from the stream and acknowledging them to the source).

The stream control manages the allocation of resources such as memory resources and processor resources (CPU resources) at the destination. In general, in compliance with the stream control, the destination sets a limit on the transmission bit rate implemented by the source which sends data to the destination. The source and the destination coordinate the transfer of data through an exchange of messages comprising queries and acknowledgements. Before the source starts sending packets, it sends a request to the destination aimed at obtained permission to start transmission. In response to this request, the destination sends a message comprising an identification of the number of packets that the source can transmit to the destination without additional authorization. This number is commonly called a “window size”. Then the source transmits the authorized number of packets to the destination and waits for the destination to verify their reception. After the destination has successfully received a packet, it sends a message in return to the source comprising an acknowledgement of reception indicating that the packet has been received successfully and in certain cases authorizing the source to send another packet. Thus, the number of packets on the network traveling in transit from the source to the destination never exceeds the authorized window size.

Thus, this mechanism for controlling the stream is based on a sliding “send window” called a congestion window (denoted as Cwnd). This congestion window contains all the frames sent out by the TCP source and not yet acknowledged by the destination TCP. The size of this window therefore conditions the maximum bit rate of the TCP in progress. Indeed, the TCP can no longer send Cwnd bytes without receiving acknowledgement. Now this acknowledgement cannot take place before a round-trip time (RTT), namely the time taken by the packet to reach its destination and for the corresponding acknowledgement to be sent back and received by the source. The source therefore can no longer send any Cwnd/RTT bytes per second. Sequence numbers are used to count down the data in the byte stream. There are always two of these numbers in each TCP segment, namely the sequence number (representing the proper sequence number of the TCP source) and the acknowledgement number (representing the destination sequence number).

FIG. 7 provides a schematic illustration of the classic structure of a TCP segment 700. The TCP segment has two parts: the first part corresponds to the TCP header 701, the second to the payload data (also called data to be transported) 702. The second part is of zero length when the connection is set up. It can also be zero by choice of the application.

The TCP header 701 comprises the following fields:

a field 703 for the port number of the source application;

a field 704 for the port number of the destination application;

a field 705 for a data sequence number (also called a data order number), identifying the position of the data to be transmitted relative to the original segment;

a field 706 for an acknowledgement number (also called a reception acknowledgement sequence number), identifying the position of the last byte received in the incoming stream. It must accompany the ACK flag at 1 (see further below);

a field 707 indicating the length of this TCP header. A value greater than 29 bytes indicates the presence of options (see field 712 described here below);

a control field 708 comprising six check bits 7081 to 7086, each defining a different flag (URG, ACK, PSH, RST, SYN and END), to influence the behavior of the TCP protocol in characterizing the use of this TCP segment 700 (see table here below). In other words, the six check bits 7081 and 7086 enable the defining of six categories of segments: URG segments, ACK segments, PSH segments, PUSH segments, RST segments, SYN segments and END segments (a same packet may belong to several of these categories).

| Flag | Meaning (if the flag is at 1) |
|---|---|
| URG | The “urgency pointer” field 711 must be |
| | exploited. |
| ACK | The “acknowledgement number” field 706 is valid |
| | and must be exploited. |
| PSH (or | This is a notification from the source to the |
| PUSH) | destination to inform it that all the data |
| | collected must be transmitted to the |
| | application without waiting for data, if any, |
| | that may follow (either because of an end of |
| | data or because of a congestion of the |
| | transmission buffer memory). |
| RST | Resetting the connection. |
| SYN | Setting the connection. The “data sequence |
| | number” field 705 contains the connection start |
| | value. |
| END | The source which has sent this TCP segment has |
| | finished sending. |

a field 709 for the size of the congestion window: each part (i.e. each machine) thus announces the size of its reception buffer memory;

a field 710 for a checksum containing a result of a computation of integrity pertaining to the entire segment (header and data);

a field 711 for an urgency pointer which is valid only if the flag URG is engaged (i.e. at 1). This field 711 then contains an offset to be added to the value of the data sequence number (contained in the field 705) of the present segment 700 to delimit a zone of pieces of urgent data to be transmitted to the application;

an options field 712 for a particular parametrizing of the TCP protocol; and

a possible padding zone to secure the total length of the present TCP segment 700 on a 32-bit word.

A selective acknowledgements (SACK) option of the TCP protocol is used to implement a selective re-transmission policy [RFC 2018]. This option is aimed at providing offering more extensive information in order to recover the losses. Indeed, the cumulated positive acknowledgements (ACKs) provide limited information: a TCP source learns of the existence of only one packet loss per RTT. The SACK option provides the TCP with the means to go beyond this limitation.

Here below in the description, a technique according to a particular embodiment of the invention is described in more ample detail in the context of an implementation of a communications tunnel between two LANs in order to enable the exchange of multimedia data between the network apparatuses of each of these LANs.

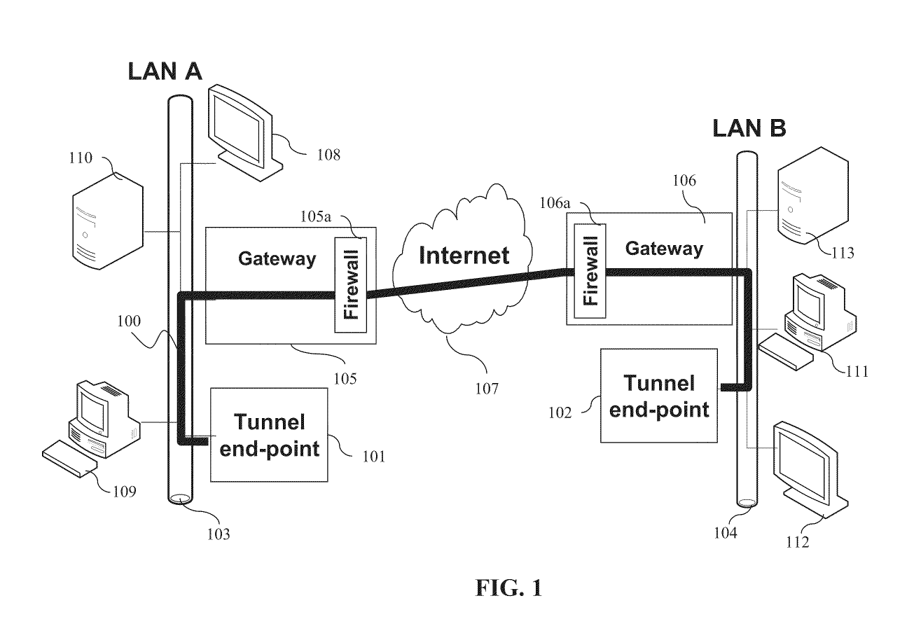

FIG. 1 provides a schematic illustration of a classic configuration of a virtual private network (VPN) implementing a communications tunnel (more simply called a “tunnel”).

A tunnel is set up 100 between a first tunnel end-point 101 and a second remote tunnel end-point 102, through a communications network 107 such as the Internet for example. This tunnel 100 interconnects a network LAN A 103 and another network LAN B 104. Each of the LANs 103 and 104 has a home gateway type high-bit-rate Internet access apparatus, 105 and 106 respectively, which can incorporate a firewall, respectively 105a and 106a. Each of the LANs 103 and 104 furthermore has PC type computers 109 and 111, servers 110 and 113 for the storage and sharing of digital multimedia data (of the audio, video and photo type) as well as digital data rendering apparatuses 108 and 112.

A tunnel end-point may be a dedicated apparatus (as shown in FIG. 1) or else it may be integrated into an audiovisual apparatus such as a digital television set. It can also be presented in a PC type apparatus in the form of a set of data-processing instructions (or software program) performing the functions associated with it.

Once the tunnel 100 is set up, the apparatuses 108, 109, and 110, connected to the LAN A 103, are capable of communicating with the apparatuses 111, 112 and 113, connected to the LAN B 104. For example, the client 108 connected to the LAN A 103 can communicate with the server 113 connected to the network LAN B 104.

In FIG. 1, a single communications network comprising only one tunnel is shown. However, it is clear that a same LAN can comprise several tunnel end-points and/or that one and the same tunnel end-point can manage several tunnels (leading to an equivalent number of tunnel end-points) to interconnect a first LAN to several other LANs. Furthermore, for the sake of simplification, the figure does not show the Internet infrastructure apparatuses (such as the routers etc.).

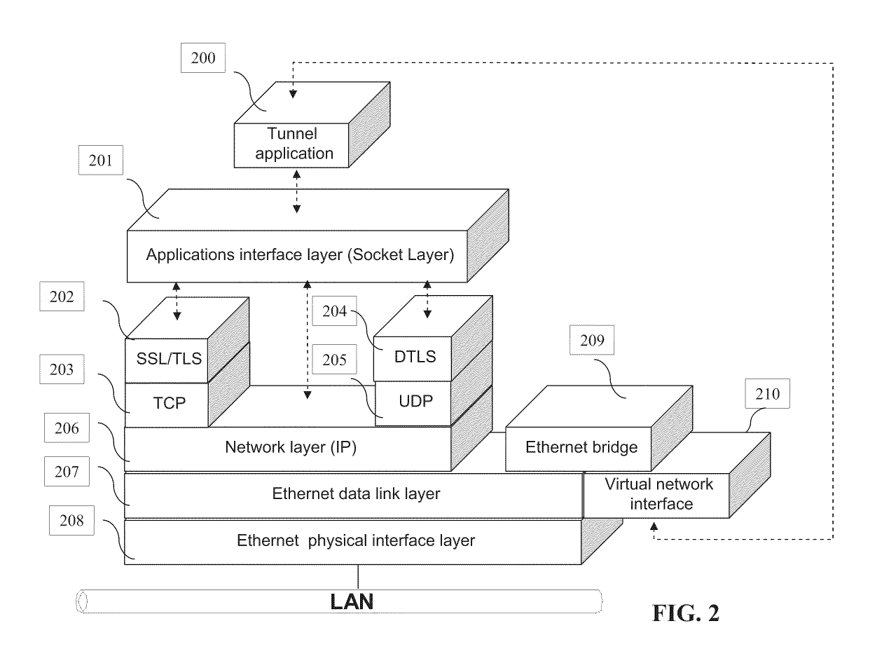

FIG. 2 schematically illustrates a classic model of a tunnel end-point in protocol-based layers, in which it is possible to implement the method according to one particular embodiment of the invention.

The following description proposes a protocol-layered model which is needed by the tunnel end-point 101 to implement the tunnel 100. A similar description can also apply to the tunnel end-point 102.

The model presented in FIG. 2 does not represent the protocol elements necessary for functions other then the implementation of the tunnel 100 such as, example, the protocol elements associated with the UpnP (Universal Plug and Play) standard.

The course taken by an Ethernet frame coming from one of the apparatuses 108, 109, 110 (connected to the LAN A 103) and having to be conveyed via the tunnel 100 up to the LAN B 104 is as follows.

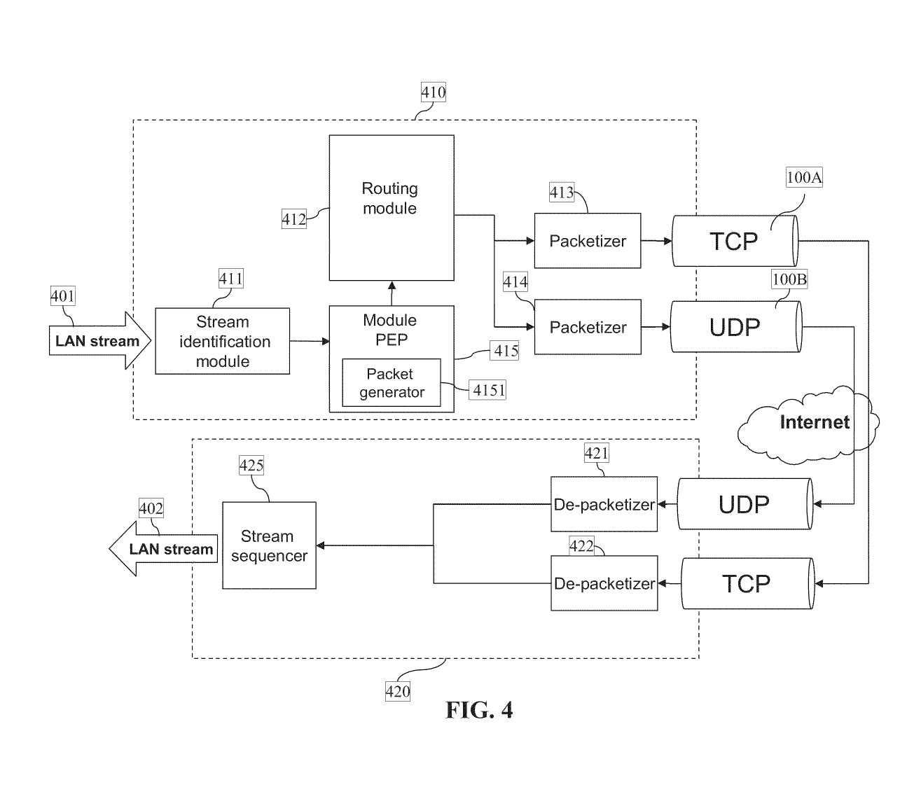

The protocol-layered model presented in FIG. 2 has a Ethernet physical interface 208 which gives the Ethernet frames coming from the apparatuses 108, 109, 110 to an Ethernet data link layer 207 for routing to a network layer 206 (for the Ethernet frames intended for the apparatus comprising the tunnel end-point) or to an Ethernet bridge layer 209 for the other Ethernet frames. The Ethernet bridge layer 209 carries out the classic operations of an Ethernet bridge such as the filtering of the Ethernet frames and the relaying of these frames to the appropriate Ethernet output port or ports. The Ethernet bridge layer 209 has the Ethernet data link layer 207 and at least one virtual network interface layer 210, emulating an Ethernet controller, attached to it. A virtual interface layer 210 is created for each tunnel instantiated by the application 200. The application 200 gives this virtual layer 210 the Ethernet frames that must be distributed throughout the virtual private network. Generally, the encapsulation protocol of the tunnel represented by the application 200 performs the operations necessary for implementing each tunnel, among them in particular the configuration, filtering and encapsulation (the formation of a tunnel packet) and the extraction of a frame. In a preferred embodiment, these operations include also the specific mechanisms of the invention, such as those described more amply here below, especially with reference to FIGS. 4 to 6.

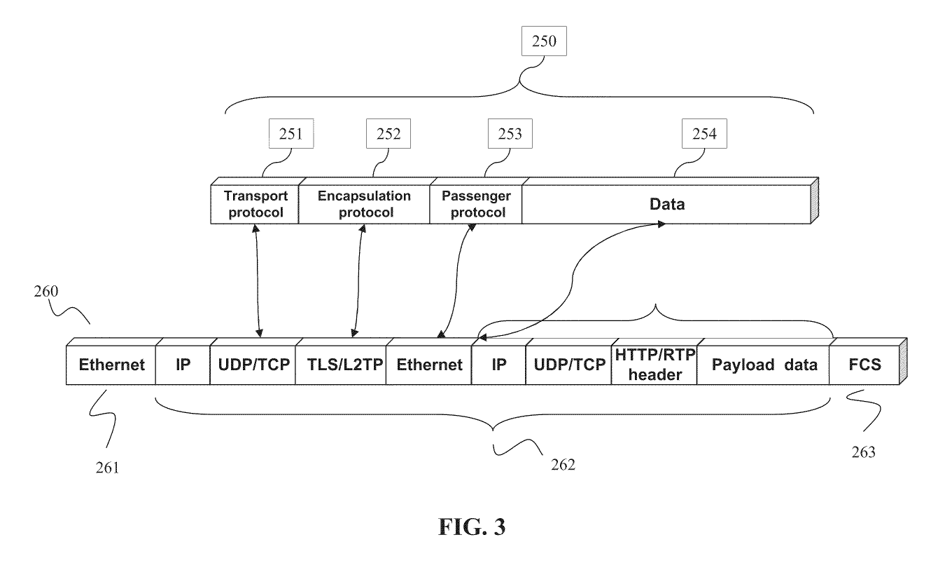

The frames received from the virtual interface 210, after processing by the application 200, are handed over in the form of packets through an applications interface layer or socket layer 201 to a reliable TCP transport protocol layer 203 or to a non-reliable UDP transport protocol layer 205, respectively secured by the SSL/TLS protocol layer 202 and the DTLS protocol layer 204. After processing by one of the two TCP layers TCP 203 or UDP 205, to form a tunnel packet 250 (FIG. 3), it is passed on to the network layer 206. The IP datagram thus formed with the tunnel packet can now be transmitted on the LAN through the link layer 207 and physical layer 208, and then propagated on the Internet through the gateway 105.

The reception of a frame coming from the tunnel 100 will take the reverse path, in the tunnel end-point, to the one presented here above.

FIG. 3 schematically illustrates a classic format of an Ethernet frame in the context of the implementation of a level 2 tunnel such as the tunnel 100 of FIG. 1. The Ethernet frame 260 conveys a level 2 tunnel packet. The Ethernet frame 260 is a frame traveling, for example, on the LAN A 103 de FIG. 1 between, firstly, the tunnel end-point 101 and, secondly, the home gateway 105 for data coming for or addressed to the LAN B 104.

The Ethernet frame 260 comprises:
an Ethernet header field 261,
a first IP datagram 262 itself conveying a level 2 tunnel packet 250, and
and an FCS (“Frame Check Sequence”) field 263.

The tunnel packet 250, contained in the IP datagram 262, has:
a header field of the transport protocol (also called an encapsulating transport protocol) 251, namely TCP or UDP in the example described in detail here;
a header field of the encapsulating protocol 252 (namely L2TP or TLS in the example described here. Such encapsulating protocols are described especially in the standard RFC-3931 (J. Lau et al, “Layer two tunneling protocol—version 3 (L2TPv3)”, March 2005) and the standard RFC-2246 (“The TLS Protocol Version 1.0”);
a header field of the passenger protocol 253, i.e. Ethernet in this example (because the frames transported through the tunnel are the Ethernet frames sent by the devices connected to the LAN A 103 or LAN B 104); and
a payload data (also called user data or applications data) field 254 which itself comprises a second IP datagram which is complete if no fragmentation has taken place during its transit from the source equipment that has generated it.

Here below in the document, the algorithms of one embodiment of the invention shall be described according to a setting up on a tunnel end-point 101 (or 102).

FIG. 4 provides a schematic illustration of the functional blocks included in the tunnel end-points according to one embodiment of the invention.

The functional architecture of each tunnel end-point (TEP) 101 or 102 consists of a sender block 410 and a receiver block 420 providing respectively for the sending and reception of data through the multi-transport tunnel 100 (i.e. through a tunnel comprising several carriers each using a transport protocol such as for example a TCP carrier and a UDP carrier).

For the sake of simplification, FIG. 4 shows only the sender block 410 of the tunnel end-point 101 and the receiver block 420 of the tunnel end-point 102.

The different protocol layers presented with reference to FIG. 2 are represented here in a simplified form for the sake of readability of the representation. Similarly, the gateways 105 and 106 have been omitted.

It must also be noted that, for the sake of readability, only two carriers namely a UDP carrier 100B and a TCP carrier 100A are represented in the diagram: this in no way restricts the number of carriers of the tunnel which may be constituted by carriers that are based on other protocols of the transport layer of the OSI model (such as the DCCP and SCTP protocols discussed briefly here below) and that may or may not have associated securing protocols (such as the TLS and DTLS protocols).

In addition to the TCP and UDP protocols, other transport protocols have been created for various uses, especially:

The SCTP carrier protocol (Stream Control Transmission Protocol) is a protocol defined by the IETF in the RFC 4960. It gives services similar to the TCP protocol providing reliability, the restoring of order to the sequences and congestion control. This SCTP transport protocol of the tunnel is considered to be the same as a transport protocol with acknowledgement and re-transmission as is the case for the TCP protocol.

the DCCP (Datagram Congestion Control Protocol) is a message-oriented transport layer communications protocol. It was defined by the IETF in the RFC 4340. It gives unicast type two-way connections type connections with the support of congestion control (like the TCP) for a non-reliable message service (like the UDP). This DCCP tunnel transport may be considered be the same as a transport protocol without acknowledgment as is the case with the UDP protocol.

The following description pertains solely to the transmission of a data stream 401 through the tunnel 100 from the tunnel end-point 101 to the tunnel end-point 102. A similar description can be applied for a transmission of streams in the reverse direction, i.e. from the tunnel end-point 102 to the tunnel end-point 101.

It must also be noted that only one data stream 401 conveyed through the tunnel 100 from the tunnel end-point 101 to the tunnel end-point 102 is considered for purposes of illustration. However, several streams similar to this stream 401 can simultaneously benefit from the advantages of the present invention.

The sender block 410 of the tunnel end-point 101 receives a stream 401 at input, coming from the LAN A 103 and is in charge of conveying the data of this stream 401 through the tunnel 100 in deriving benefit from the TCP carrier 100A and UDP carrier 100B.

The receiver block 420 of the tunnel end-point 102 receives the data from the tunnel 100 and restores a data stream 402 on the LAN B 104, this data stream corresponding to the original stream 401 (for example the stream 402 is identical to the stream 401 if there has not been any loss on the Internet, but the distribution of the packets of the stream 402 is probably different from that of the stream 401 because of the fluctuating latencies between the carriers of the multi-transport tunnel (100).

In one embodiment of the invention, the passenger stream 401 is formatted according to the TCP: for example, an FTP on TCP transport is a preferred solution of the prior art for the transfer of files; the HTTP on TCP transport is a preferred solution of the prior art for the web data (for example the UPnP/DLNA standards use HTTP for the transfer of videos).

A sender block 410 of the tunnel end-point 101 includes the following elements:

a stream identification module 411 in charge of detecting and selecting the new streams received from the LAN 103;

a routing module 412 in charge of routing each of the packets streams 401 of the LAN 103 to one of the carriers of the tunnel 100;

a PEP module 415 manipulating the streams selected by the stream identification module 411. This PEP module 415 is in charge of copying, if need be, information contained in certain of the TCP segments of the stream 401 so that thereafter the information copied (i.e. the pieces of information resulting from the copying) are transmitted more speedily on the tunnel and ultimately to the concerned destination by the end-to-end connection for the stream 401;

packetizers 413 and 414, each dedicated to one carrier of the tunnel 100, in charge of encapsulating the data coming from the routing module 412 (the segments of the original stream 401 and copied information if any of this stream 401).

The stream identification module 411 selects the new streams to be given to the PEP module 415, and the method of the invention is applied to these new streams. In the end, the stream identification module 411, depending for example on the class of service of the streams detected, selects at least one TCP type stream 401 and sends each packet of this stream to the PEP module 415.

Here below in the description, it is assumed that the selected stream 401 is intended to be encapsulated by the sender block 410 of the tunnel end-point 101 according to an encapsulating transport protocol with acknowledgement (for example the TCP protocol) for transmission on the carrier using this protocol (TCP carrier in the above mentioned example).

The PEP module 415 is adapted to determining the nature of the segments received and the aptness of handling particular pieces of information of these segments (especially the segments pertaining to ACK and PSH segments). The PEP module 415 is in addition responsible for creating (through the generation module 4151) new TCP passenger segments (also called, depending on the embodiment considered, created segments) corresponding to a part of the information conveyed by selected segments of the original stream 401. These created TCP passenger segments are then intended for transmission through the UDP carrier. The PEP module 415 is finally capable of proposing this routing decision for the created segments to the routing module 412 which then carries out the routing of these segments on the carrier indicated by the PEP module 415.

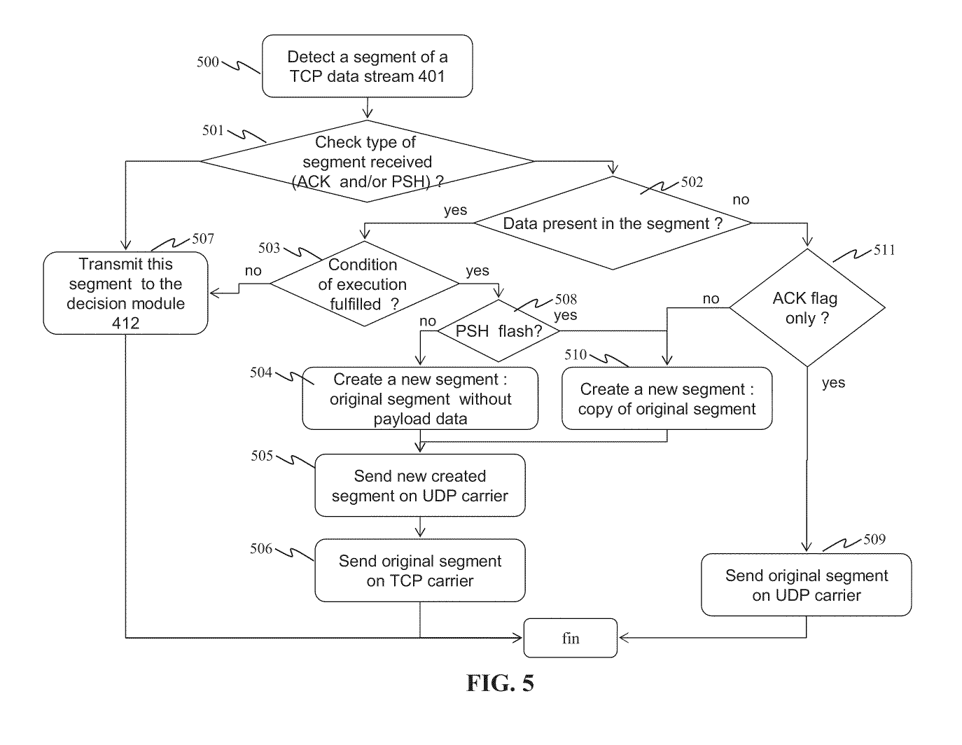

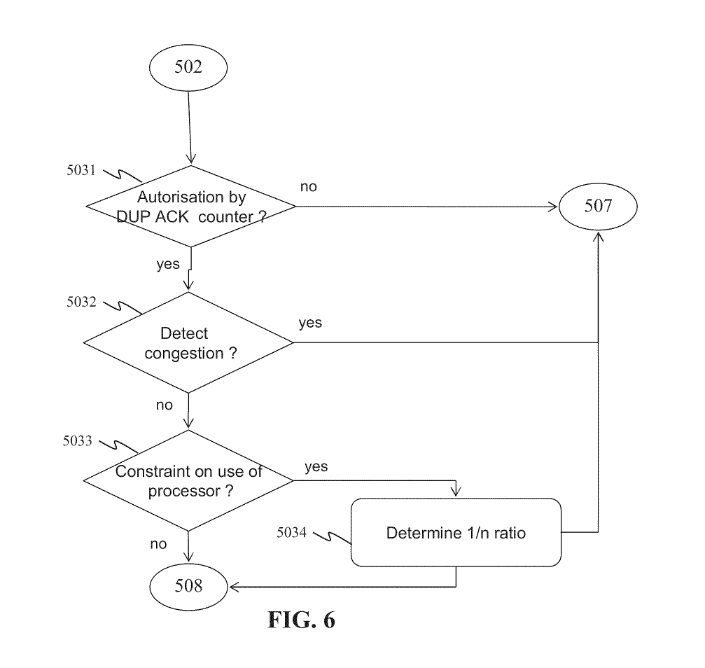

One particular embodiment of the algorithm implemented by the PEP module 415 is described more amply here below, especially with reference to FIGS. 5 and 6.

The receiver block 420 of the tunnel end-point 102 comprises the following elements:

de-packetizers 421 and 422, each dedicated to a carrier of the tunnel 100, responsible for de-encapsulating the data coming from the tunnel 100;

a stream sequencer 425 responsible for delivering and clocking, on the LAN 104, the packets of the stream 402 obtained at output of the tunnel.

FIG. 5 is a flowchart of a particular embodiment of the method of the invention, implemented by a tunnel end-point.

As an example, we again consider only the transmission of the data stream 401 through the tunnel 100 from the tunnel end-point 101 to the tunnel end-point 102 and, in this context, FIG. 5 illustrates the working of the sender block 410 of a tunnel end-point 101.

All the steps of the algorithm of FIG. 5 can be implemented equally well:

All the steps of the algorithm of FIG. 5 can be implemented equally well:

by the execution of a set of computer instructions executed by a reprogrammable computing machine such as a PC type apparatus, a DSP (a digital signal processor) or a microcontroller can be stored in a storage medium that is detachable (for example a floppy disk, a CD-ROM or a DVD-ROM) or non-detachable; or else

by a dedicated machine or component such as an FPGA (Field Programmable Gate Array) or an ASIC (Application-Specific Integrated Circuit).

The step 500, performed by the stream identification module 411, consists in warning the PEP 415 module of the arrival of a packet (also called a segment) of a multimedia stream 401 using a transport protocol with acknowledgement. This detection of a new stream 401 is customized according to the transport protocol of the stream 401; for example, any stream according to the TCP is liable to be selected. This TCP stream selection can be reduced according to:

quality of service criteria (class of service conveyed in the stream 401);

a selecting by the user of the services to be improved (for example the transport of videos on HTTP);

a selection by the user of the apparatuses of the LAN 103 and 104 (for example the UPnP apparatuses) on which an acceleration of the transport is desired (for example the UPnP apparatuses);

etc.

The next steps are performed by the PEP 415.

The step 501 is a step for determining which segment categories belong to the received segment. In one particular embodiment of this step 501, the presence of the ACK and PSH check bits (flags) in the received segment are detected so as to determine whether this segment is an ACK segment and/or PSH segment. This is done by analysis of the fields 7082 and 7083 of the TCP header present in FIG. 7. If none of these ACK and PSH flags is positioned (a position flag means that the corresponding bit is set at 1), the operation passes to a step 507 in which the TCP segment received is directly transmitted to the routing model 412.

In one particular embodiment of the invention, if the ACK flag is positioned at the same time as the flag SYN or END, then the received segment is simply sent to the routing module 412 (the flags SYN or END indicate TCP connection segments which are unique and whose transport is preferably reliabilized. This does not require the use of the UDP carrier of the tunnel instead of the TCP carrier of the tunnel for certain pieces of information or data contained in the received segment).

If not (i.e. if the received segment is an ACK and/or PSH segment, but not an SYN or END segment), the test step 502 is executed and consists in determining the presence of payload data (also called transported data) in the received segment (field 702 not empty). To this end, the “total_length” value (indicated in number of bytes) of the IP header should not exceed the sum of the size of the IP header (indicated in number of four-byte words which form the header) plus the size of the TCP header (indicated in number of four-byte words that form the header). The standard size of the IP header is five words (or 20 bytes), that of the TCP without options (i.e without using the options field 712) is also five words. Hence, a TCP segment indicating a “total_length” size in the IP header greater than 40 bytes contains data (zone 702 not vacant according to FIG. 7).

If the test step 502 leads to determining that the received segment does not contain any payload data, a check is made at the step 511 to see if it is an ACK segment and/or a PSH segment:
if it is an ACK segment only (without PSH), the operation passes to the step 509 in which the transmission of the segment on the UDP carrier of the tunnel is prepared: the segment is sent to the routing module 412 with the instruction for dispatch on the UDP carrier. This requires no additional processing and can be executed at any time (no CPU load required);
if it is a PSH segment (or an ACK and PSH segment), this segment with a positioned PSH flag is used to inform the TCP destination that it must transmit the data received to the upper layers in order to release the TCP sending buffer memory of the TCP source. It is important that this segment should swiftly reach its destination, but in preserving reliability. This is why the step 510 is aimed at entirely duplicating this segment (i.e. creating a new segment identical to this segment) to send two identical segments on each of the two TCP and UDP carriers of the tunnel. Then, the step 505 is executed.

If the test step 502 leads to determining that the TCP segment received contains payload data, the test step 503 is implemented. This test step 503, described in detail with reference to FIG. 6, leads to the execution of the process for creating and sending a new segment, according to one embodiment of the invention (steps 504 or 510, and 505, 506), if one or more conditions is verified.

If the result of the test step 503 is positive, the operation passes to the step 508. If not, it passes to the step 507 in which the TCP segment is transmitted directly to the routing module 412.

At the step 508, a check is made to see if the received segment contains a flag PSH positioned (corresponding bit 7083 set at 1), thus indicating that it is a PSH segment:
if it is a PSH segment (or an ACK and PSH segment), the segment with the PSH flag positioned is used to inform the TCP destination that it must transmit the data received to the higher layers (in order to release the TCP sending buffer memory of the TCP source, or at end of transmission of a data block). The operation then passes to the previously described step 510, aimed at entirely duplicating this segment. Then, the steps 505 and 506 are executed;
if it is not a PSH segment, it is an ACK segment (since the test step 501 has previously indicated that it was an ACK segment and/or PSH segment); then the step 504 is implemented, and then the steps 505 and 506.

At the step 504, a new segment has to be created. To this end, the header of the received segment is copied out (i.e. duplicated) into a new packet (since it is a level 2 tunnel, the Ethernet, IP and TCP headers are considered), but the payload data of the original packet are not copied out (i.e. duplicated) into the new packet. Then, an updating of the TCP header is performed along with an updating of the TCP header. The original segment is left intact.

The updating of the TCP header comprises the following actions:

preserving solely the ACK flag (7082 check bit) amongst the flags of the TCP header;

modifying the value contained in the sequence number field 705, and subtracting the number of payload data bytes contained in the received original segment from the current value;

computing the check sum of the TCP header 701, and updating the checksum field 710.

It will be noted that before being updated, the entire TCP header 701 is copied, including the options field 712. This makes it possible especially to support the SACK option of the TCP protocol.

The updated of the IP header comprises the following actions:

computing the total length of the packet at the IP level and updating a corresponding field;

computing the checksum of the IP header and updating a corresponding field.

At the step 505, the new segment created at the step 504 or 510 is transmitted on the UDP carrier of the tunnel. To this end, the new segment created is sent to the routing module 412 with the sending instruction for sending on the UDP carrier. The advantage is to ensure the rapidity of transfer on the tunnel.

In the step 506, the original segment is transmitted on the TCP carrier of the tunnel. To this end, the original segment is sent to the routing module 412 with the instruction for sending it on the TCP carrier. The advantage of this is that the reliability of the transfer on the tunnel is ensured.

It is also possible, in one variant of the step 504, to:

not copy out (i.e. duplicate) certain pieces of information contained in the original packet (in order to put them into a new packet to be transmitted on the UDP carrier), but extract them to the original packet;

build a first new packet with the extracted information (and in recomputing the associated checksum) and transmit this first new packet through the UDP carrier of the tunnel, and

build a second new packet with the information and remaining payload data (and in computing the associated checksum) and transmit this second new packet through the TCP carrier of the tunnel.

However, the embodiment presented above (the case of “copying information”) is easier to implement than this variant because it is necessary to build only one new packet (there is no need to build a second new packet mentioned here above). It is also more reliable because the entire content (information and payload data) of the original packet is transmitted through the TCP carrier.

FIG. 6 is a detailed flowchart of a particular embodiment of the test step 503 in FIG. 5.

The step 5031 is a step for determining the overall number of acknowledgements (original ACK segments received and supplementary ACK segments created by the invention) for a same acknowledgement number in order to verify that the additional ACK segments created by the invention do not possess an excessively large number of ACK segments which would lead the TCP source to go into retransmission (in the event of reception of three duplicate ACK segments, also named DUP-ACK according to the TCP protocol).

To this end, a referencing table for the streams 401 is managed. This table 401 contains the number of original ACK segments received and the number of additional ACK segments created by the invention, for every stream 401 identified by a FIG. 4-uplet (source address SA, destination address DA, source port S.Port, destination port D.Port). Anew stream input 401 in this table corresponds to the reception of a TCP segment coming from the local network with the flag SYN at 1.

The pieces of information contained in this table of information on the data streams 401 are extracted from the IP datagrams of the stream 401. These pieces of information contain, for each data stream, the source address “SA” (corresponding to the source address field of the IP datagram), the destination address “DA” (corresponding to the destination field of the IP datagram), the source port “S.Port” and the destination port “D.Port” contained in the IP datagram. For each entry of the table, the following pieces of complementary information are available, namely:

the last sequence number acknowledged by the ACK segments received (updated by the step 501, by the reading of the “acknowledgement number” field 706);

the number of times that this ACK segment has been received (updated by the step 502) denoted as NR; and

the number of times that a supplementary ACK segment has been created, with the same acknowledgement information as this ACK segment (updated by the step 505), and denoted as ND.

Thus, the test step 5031 is positive, and the operation passes to the step 5032 if one of the following conditions is verified:

condition 1: “NR≧S+1” (which means that, seen from the destination TCP side, a retransmission procedure according to the passenger transport protocol is or should be initiated), then the TCP destination of the passenger stream wishes to inform the TCP source that there are transmission errors: no limits on the generations of a new ACK segment for acceleration according to the invention;

condition 2: “NR+ND<S” (which means that, seen from the TCP source side, the retransmission procedure “does not need to be initiated” even if it receives a supplementary created ACK segment), then the TCP source does not yet deem it to be the case that there has been a transmission error, and an ACK segment created according to the invention will not create any unwanted retransmission.

S is a threshold value for determining, according to the TCP protocol, the need for retransmission of a segment considered to be lost following the reception of a number of segments DUP ACK equal to this threshold value. This threshold value S is commonly called “DUP ACK threshold” and has a value of 3.

If the test step 5031 is negative, the operation pas ses to the step 507: there is a suspension of the creation of DUP ACK segments in order to prevent the TCP source from going into retransmission.

For example, the following procedure can be applied (for the same ACK segment):

| Index of | | | | |
|---|---|---|---|---|
| Original | | | | |
| Received ACK | | | | |
| Segment | NR | Action | ND | Nmax |
| #1 | 1 | Condition 2 verified: authorization | 0 | 2 |
| | | to execute the step 508 (transmission | | |
| | | of the original ACK segment and of a | | |
| | | created ACK segment): | | |
| #2 | 2 | Conditions 1 and 2 not verified: | 1 | 3 |
| (1^{st} DUP ACK) | | execute step 507 (no creation of | | |
| | | additional ACK segment, and | | |
| | | transmission of original ACK segment). | | |
| #3 | 3 | Conditions 1 and 2 not verified: | 1 | 3 |
| (2^{nd} DUP ACK) | | modify original ACK segment (ACK | | |
| | | flag set is 0, with role of information | | |
| | | related to the acknowledgement and | | |
| | | computation of the checksum of the TCP | | |
| | | header only) then execute the step 507 | | |
| | | (no creation of supplementary segment | | |
| | | and no transmitted ACK segment). | | |
| #4 | 4 | Condition 1 verified: execute step | 1 | 5 |
| (3^{rd} DUP ACK) | | 508 (transmit original ACK segment | | |
| | | and a created ACK segment) | | |

Nmax is the maximum number of ACK segments perceived (after the current iteration of the decision process, leading to the sending or non-sending of a supplementary ACK segment) by the TCP source of the data to which the ACK segment corresponds. Nmax is a theoretical number, assuming that there is no loss of transport on the UDP carrier.

ND is counted here before the current iteration of the above-mentioned decision process.

It will be noted that the ACK segment #3 is managed in a particular way because the sending of the created ACK segment according to the invention during the previous iteration of the decision process (with the same information and acknowledgement as the ACK segment #2), has implemented the DUP ACK counter of the TCP destination: this filtering of the ACK #3 segment therefore has the effect of restoring the counters of the TCP destination as if the invention had not been applied. The filtering of the ACK #3 segment can therefore be summarized as follows:
if the following two conditions are verified:
   “NR<S+1”, which means that, seen from the destination TCP side, a retransmission procedure according to the passenger transport protocol does not need to be engaged (even in counting the segment ACK #3), and
   “NR+ND≧S+1”, which means that, seen from the TCP source side, this procedure of retransmission will have to be engaged if it receives the segment ACK #3,
then, a modified segment (non-ACK) obtained from the received original ACK segment is transmitted on the TCP carrier (the information related to the acknowledgement is extracted from the ACK segment #3 to obtain a modified segment which is not an acknowledgement segment).

The step 5032 is a step for checking to see if there is congestion n on the WAN. If this is not so, the operation passes to the step 5033. If not, it passes to the step 507 (the creation algorithm is stopped and supplementary segments are sent) because it is unnecessary to increase the number of packets transmitted (no supplementary ACK segment) and also unnecessary to accelerate the source of the TCP stream in its transmission. For example, the ECN (Explicit Congestion Notification) is an extension of the internet protocol (IP) which provides for the preliminary notification of the congestion of the network (RFC 3168) for example in the presence of an overload of the path between two hosts (such as tunnel endpoints). Thus, a tunnel endpoint is made aware of a temporal congestion via the return of information 430 from the carriers of the tunnel.

The step 5033 is a step for checking to see if the processor resources (CPUI resources) of the tunnel end-point are not completely used. For example, if the CPU resource occupation rate is in the neighborhood of 80%, the tunnel end-point has but little room for maneuver. It may be recalled that the main load of a tunnel end-point (in a pure software application) relates to operations of encapsulation and/or decapsulation of data. In this case, it is unnecessary to seek to accelerate TCP passenger stream, the consequence of which would be to overload the tunnel end point. However, a CPU with a load of less than 50% can be taken to be a condition that enables the processing of all the packets (with a passage to the step 508). Between these two values (50% and 80%), the application of the step 5034 accelerates the stream 401 without exceeding the constraints of the CPU. It may be recalled that these threshold values are given by way of information and that these values are closely linked to the mode of implementation of all the algorithms for the encapsulation and/or decapsulation of tunnel end-points: either in software form with hardware acceleration of certain functions or completely in hardware form. As an alternative, a definition of these thresholds can be provided by a user (through a web interface for configuring the tunnel end-point for example). The step 5034 is then used to determine a ratio 1/n of application of the step 508 for the packets received: each received segment is counted and 1 amongst n of these packets is directed towards the step 508 (the others after the step 507).

This ratio 1/n is preferably determined in regular time slots by decrementing n (from 10 to 1). For example, it is ascertained that by using the value 1/10 of packets transmitted for processing to the step 508, the maximum threshold of CPU resource occupation mentioned here above is always complied with. If the answer is yes, then the upper value 1/9 is tested for example, then 1/8 and so on and so forth. If the maximum. CPU resource occupancy threshold is exceeded, then it is possible to reduce the rate of creation of additional segments by one unit (for example in passing from 1/6 to 1/7) and so on and so forth.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A method for transmitting packets of a two-way passenger data stream set up between a first terminal device and a second terminal device, wherein the two-way passenger data stream is compliant with a passenger transport protocol with acknowledgement defining a plurality of packet categories and is intended to be encapsulated by a manager device according to an encapsulating transport protocol with acknowledgement, the method comprising:
obtaining a packet of a passenger stream transmitted from the first terminal device to the second terminal device;
making a first check to see if the obtained packet belongs to at least one predetermined category among the plurality of packet categories; and
encapsulating, in an event that the first check is positive, at least one part of data of the obtained packet according to an encapsulating transport protocol without acknowledgement.

2. The method according to claim 1, wherein the manager device makes a second check to see if the obtained packet includes payload data and wherein, in the event that the first and second checks are positive, the manager device carries out a packet creating phase for the obtained packet or for at least one of obtained packet, the packet creating phase comprising:
creating a new packet into which a part of the obtained packet related to the at least one predetermined category has been copied;
encapsulating the new packet according to the transport protocol without acknowledgement; and
encapsulating the payload data according to the transport protocol with acknowledgement.

3. The method according to claim 2, wherein encapsulating the payload data according to the transport protocol with acknowledgment comprises encapsulating the obtained packet according to the transport protocol with acknowledgment.

4. The method according to claim 2, wherein encapsulating the payload data according to the transport protocol with acknowledgement comprises:
modifying the obtained packet by extracting the copied part from the obtained packet; and
encapsulating the modified packet according to the transport protocol with acknowledgement.

5. The method according to claim 2, wherein, in an event that the first check is positive and the second check is negative, the manager device performs a step for encapsulating the obtained packet according to the transport protocol without acknowledgement.

6. The method according to claim 1, wherein the at least one predetermined category belongs to a group comprising:
a category grouping together acknowledgement packets transmitted by the first terminal device to inform the second terminal device of a reception of one or more packets pre-transmitted by the second terminal device, and
a category grouping together complete data transmission packets transmitted by the first terminal device to inform the second terminal device that the payload data collected by the second terminal device must be transmitted to a destination application without waiting for following payload data if any.

7. The method according to claim 2 wherein, if the obtained packet is an acknowledgement packet, the manager device makes a third check to see if one of two following conditions is fulfilled:
seen from a destination apparatus that has generated the acknowledgement packet, a re-transmission of data according to the passenger transport protocol is or should be initiated, and
seen from a source apparatus, a re-transmission of data according to the passenger transport protocol should not be initiated even if the source apparatus receives the acknowledgement packet as well as a new packet created by the packet creating phase, and wherein the packet creating phase is performed only in an event that the first, second and third checks are positive.

8. The method according to claim 7,
wherein the manager device makes a fourth check to see if two following conditions are fulfilled:
seen from the destination equipment, having generated the acknowledgement packet, a re-transmission of data according to the passenger transport protocol should not be initiated, and
seen from the source apparatus, a re-transmission of data according to the passenger transport protocol will have to be initiated if the source apparatus receives the acknowledgement packet,
wherein, in an event that the fourth check is positive, the manager device:
modifies the obtained packet by extracting the copied part from the obtain packet to produce a modified packet that does not have an acknowledgement packet, and
encapsulates the produced modified packet according to the transport protocol with acknowledgement.

9. The method according to claim 2, wherein the manager device makes a fifth check to see if the obtained packet belongs to at least one category different from the at least one predetermined category, and wherein the packet creating phase is performed only in an event that the first, second and fifth checks are positive.

10. The method according to claim 9, wherein the at least one different category belongs to a group comprising:
a category combining packets for initializing connections between a first terminal device and a second terminal device; and
a category grouping together packets indicating end of transmission.

11. The method according to claim 2, wherein the manager device makes a sixth check to see if it has been determined that there is a congestion on a network transmitting the passenger stream and wherein the packet creating phase is performed only in an event that the first, second and fifth checks are positive.

12. The method according to claim 2, wherein the manager device makes a seventh check to see if a rate of use of processor resources of the manager device is smaller than or equal to a predetermined threshold,
and the packet creating phase is performed only in an event that the first, second and seventh checks are positive.

13. The method according to claim 1, wherein a tunnel comprising a first carrier and a second carrier is implemented between the first terminal device and the second terminal device, and wherein the encapsulating transport protocol with acknowledgement is used with the first carrier, and the encapsulating transport protocol without acknowledgement is used with the second carrier, and wherein the manager device is a tunnel end-point placed between the first terminal device and the tunnel.

14. A computer readable storage medium storing computer-executable instructions for use in transmitting packets of a two-way passenger data stream set up between first and second terminal devices, wherein the two-way passenger data stream is compliant with a passenger transport protocol with acknowledgement defining a plurality of packet categories and is intended to be encapsulated by a manager device according to an encapsulating transport protocol with acknowledgement, and wherein the computer-executable instructions, when executed by a computer, cause the computer to perform operations comprising:
obtaining a packet of a passenger stream transmitted from the first terminal device to the second terminal device;
making a first check to see if the obtained packet belongs to at least one predetermined category among the plurality of packet categories; and
encapsulating, in an event that the first check is positive, at least one part of data of the obtained packet according to an encapsulating transport protocol without acknowledgement.

15. A manager device capable of participating in a transmission of packets of a two-way passenger data stream set up between a first terminal device and a second terminal device, the two-way passenger stream being compliant with a passenger transport protocol with acknowledgement defining a plurality of packet categories, the passenger stream being intended to be encapsulated by a manager device according to an encapsulating transport protocol with acknowledgement, the manager device comprises:
an obtaining unit which obtains a packet of a passenger stream transmitted from the first terminal device to the second terminal device;
a checking unit that makes a first check to see if the obtained packet belongs to at least one predetermined category among the plurality of packet categories; and
an encapsulating unit which, in an event that the first check is positive, encapsulates at least one part of data of the obtained packet according to an encapsulating transport protocol without acknowledgement.

16. A method for transmitting packets of a Transmission Control Protocol (TCP) passenger stream from a first terminal device to a second terminal device, the TCP passenger stream being intended to be encapsulated by a manager device according to an encapsulating transport protocol with acknowledgement before being transmitted to the second terminal device, wherein the manager device performs:
encapsulating acknowledgement portions of TCP passenger packet received from the first terminal device; according to an encapsulating transport protocol without acknowledgement.

17. The method according to claim 16, wherein the manager device further performs:
duplicating the acknowledgement portions of the TCP passenger packets received from the first terminal device;
encapsulating the TCP passenger packets according to the encapsulating transport protocol with acknowledgement; and
encapsulating the duplicated portions of the TCP passenger packets according to the encapsulating transport protocol without acknowledgement.

18. The method according to claim 16, wherein the encapsulating transport protocol with acknowledgement is TCP and the encapsulating transport protocol without acknowledgement is User Datagram Protocol (UDP).
